(19) United States
(12) Patent Application Publication
(10) Pub. No.: US 2016/0339988 A1
(43) Pub. Date: Nov. 24, 2016

(54) DAMPING DEVICE AND DAMPING CONTROL METHOD

(71) Applicant: INVENTUS ENGINEERING GMBH, ST. ANTON I.M. (AT)

(72) Inventors: MARKUS MAYER, SULZ (AT); STEFAN BATTLOGG, ST. ANTON I.M. (AT); GERNOT ELSENSOHN, ST. ANTON I.M. (AT); JUERGEN POESEL, BLUDENZ (AT)

(21) Appl. No.: 15/158,061

(22) Filed: May 18, 2016

Related U.S. Application Data
(63) Continuation-in-part of application No. 14/614,029, filed on Feb. 4, 2015.
Application No. 14/614,029 is a division of application No. 13/927,874, filed on Jun. 26, 2013, now Pat. No. 9,051,988.

(30) Foreign Application Priority Data
Jun. 26, 2012 (DE) 10 2012 012 532.1
May 18, 2015 (DE) 10 2015 107 734.5

(51) Int. Cl. B62K 25/04; F16F 9/50; F16F 9/53; B62K 25/08; B62K 25/28

(52) U.S. Cl. CPC B62K 25/04; B62K 25/08; B62K 25/286; F16F 9/535; F16F 9/50; B62K 2025/044; B62K 25/30

(57) ABSTRACT

Damper device and method for controlling the damping of a relative movement of two connecting units which can move relative to one another. A controllable damper with a damping valve with a magneto-rheological fluid is provided between the two units for damping relative movements. The damping valve is assigned a magnetic field-generating device for generating and controlling a magnetic field. Measurement data sets relating to a relative movement of the connecting units with respect to one another are acquired and pre-processed with a filter device. A data set derived from an acquired measurement data set is stored in the memory device. A filter parameter set is determined from the stored data set as a function of the analysis. A control data set is derived from the measurement data set with the filter parameter set. The damper device is controlled with the control data set.

### DESCRIPTION

The present invention relates to a damper device and to a control method. The damper device here has two connecting units which can move relative to one another and between which at least one controllable damper is provided for damping relative movements, wherein the damper has at least one first damper chamber and at least one assigned damping valve. The damping valve has a damping duct with a magneto-rheological fluid. The damping valve is assigned a magnetic field-generating device which serves to generate and control a magnetic field. A type of open state of the damping valve is influenced thereby.

The damping in the form of oscillations and/or shocks has a large influence on e.g. the travel properties of vehicles and therefore constitutes an important feature, in particular in the case of sporty vehicles. The use of a damper permits improved ground contact and allows sporty riding even on roads with many bends. Wheel-mounted dampers which switch in the millisecond range and have a magneto-rheological basis permit a comfortable and safe method of operation. When used in e.g. the steering column or for absorbing energy in seat belts when accidents occur, such magneto-rheological dampers permit optimum adaptation to the accident scenario and therefore allow injuries to the occupants to be minimized.

The setting of the damping properties and, where appropriate, the spring properties is generally indispensable for the optimum utilization of the advantages of damping in vehicles. Criteria for the adjustment are here, for example, the weight of the object to be damped and the properties of the terrain in which the vehicle is to travel. Different damping properties are appropriate when riding on an even underlying surface than when riding off-road. In order to make available optimum damping properties at any time, electrically controllable magneto-rheological damper devices have become known which permit comfortable adjustment of the damping properties at any time.

DE 10 2012 012 535 A1 has disclosed a damper device and a method for operating a damper device, in which the damper device comprises a controllable damping valve having a field-generating device with which a field-sensitive medium such as a magneto-rheological fluid can be influenced in order to influence the damping force of the damper device by applying a field strength of the field-generating device. In this known damper device, the damping force of the damper device is adjusted in real time. The damper is not set to a specific type of underlying surface here but rather is adapted to the current state at any time. To this end, events in the form of shocks are detected, and a relative speed of the ends of the damper is acquired periodically. For the purpose of damping, a characteristic value is derived from the relative speed in real time and in turn a field strength which is to be set is derived from a damper characteristic curve with the characteristic value. The field strength which is to be set is generated in real time with the field-generating device in order to adjust the damping force automatically in a direct fashion. With this known damper device, it is possible to deal with all types of shocks in a flexible fashion, since after the detection of a relative movement the damper device is adjusted in directly adapted fashion to the detected relative movement.

The known damper device functions very reliably and switches within a few milliseconds and significantly more quickly than the prior art, with the result that the damper device is continuously adapted to the currently prevailing conditions e.g. while traveling over a root or a stone during cycling. While, for example, when traveling on an even underlying surface the damper remains at a hard setting, so that drive energy is not unnecessarily dissipated in the damper device. The damper device operates very satisfactorily in principle. However, it has become apparent that in some situations, if, for example, the damper device experiences slow manual spring compression on a bicycle, the damper device is not deflected in a soft fashion, which the damper device should permit at a low spring compression speed, but instead outputs a scratching or scraping feedback to the user's hand. A similar scratching or scraping sensation can sometimes be felt by the user in his palms which rest on the handlebars when he rides along a virtually completely even road. In contrast, when genuine shocks occur, such things do not occur and the shock absorber damps as expected in the case of relatively strong and also in the case of relatively weak shocks. The “scratching” or “scraping” or “rattling” occurs perceptibly at quite low loads. When manual spring compression occurs, the impression can arise that the shock absorber does not react quickly enough, and that during the damping process a periodic transition takes place from very short active blocking and release and therefore “scratching” spring compression. The resulting resonance can be felt by the user. Such a phenomenon also occurs in other fields of use. The damper device then does not experience such soft spring compression as it should.

In order to remedy this, the measurement data was filtered, which led, however, to a considerable delay which is disadvantageous in terms of driving dynamics or performance during the reaction of the damper device, as a result of which shocks were absorbed too late, and large shocks were not absorbed in good time. This all takes place within microseconds. In order to prevent an excessively great delay during the reaction of the damper device, the measuring frequency was increased in order to obtain the correct reaction of the damper device and therefore a softer transition in all regions at any time, on the basis of a more rapid sequence of the measured values. However, increasing the measuring frequency did not improve the spring compression and spring extension behaviors either. And this was the case even though the damper device can be fully adjusted within a few milliseconds.

Therefore, the object of the present invention is to make available a damper device with which a more rapid and therefore better response behavior and subsequent damping behavior of a controllable damper device is made possible.

This object is achieved by means of a damper device having the features of claim 1 and by means of a method for controlling a damper having the features of claim 11. Preferred developments are the subject matter of the dependent claims. Further advantages and features of the present invention emerge from the general description and the description of the exemplary embodiments.

An inventive damper device comprises two connecting units which can move relative to one another and between which at least one controllable damper with a magneto-rheological medium, fluid or damping fluid is provided for damping relative movements such as e.g. shocks or oscillations. The damper has at least one first damper chamber and at least one damping valve which is connected thereto. The at least one damping valve is assigned at least one magnetic field-generating device which serves to generate and control a magnetic field in at least one damping duct of the damping valve. The, or at least one, magneto-rheological fluid is at least partially provided in the damping duct. Furthermore, at least one control device and at least one memory device are provided. At least one sensor device is provided for acquiring measurement data sets relating at least to a relative movement of the connecting units with respect to one another. A multiplicity of data sets can preferably be stored in the memory device. A filter device is provided for pre-processing the measurement data sets. At least one data set, derived from a measurement data set acquired with the sensor device during the relative movement of the connecting units which can move relative to one another, can be stored in the memory device. The measurement data set and/or the derived data set preferably comprises at least one speed signal and, in particular, at least one acceleration signal for the relative movement of the connecting units with respect to one another. An analysis device is provided which is designed and configured to analyze at least one stored data set and to determine a filter parameter set as a function of the result of the analysis. The control device is preferably designed to select a filter parameter set with relatively strong filtering in the case of speed signals and acceleration signals which are low in absolute value, and to select a filter parameter set with less filtering in the case of speed signals or acceleration signals which are relatively high in absolute value. The control device is designed to derive a control data set from the measurement data set with the filter parameter set, with the result that the control device controls the damper device at least partially or even completely with the control data set.

The inventive damper device has many advantages. A considerable advantage of the damper device according to the invention is that the acquired measurement data sets are analyzed with the analysis device with the result that a filter parameter set is determined as a function of the result of the analysis and is used to derive a control data set from the measurement data set, with which control data set the damping valve of the magneto-rheological damper is at least partially controlled. By analyzing the measurement data sets of the relative movement of the connecting units which can move relative to one another, in each case a suitable filter parameter set is obtained in order to ensure a rapid and, in all situations, sufficiently soft response behavior of the damper device.

The term data set is understood in the sense of the present invention to mean a data set with at least one value or measured value contained therein. It is also possible and preferred for a data set to contain a plurality of different values or parameters. A measurement data set can therefore contain, for example, an item of travel information and an item of speed information and also an item of acceleration information and others of the like. However, it is also possible for a measurement data set to contain only a single measured value. The same also applies to a derived data set which is stored in the memory device and also to a control data set which is obtained from the stored data set and/or the measurement data set. In a similar way, a filter parameter set can contain one or more filter parameters. A parameter set preferably comprises a plurality of parameters. However, it is also possible for a parameter set to contain just one parameter.

A derived data set which is stored in the memory device is also referred to below as a “stored data set”. The derived and stored data set can be identical to the associated measurement data set or is acquired therefrom by pre-processing. For example, standardization can be carried out.

In particular, the control device is designed and configured to analyze at least one stored data set and to determine a filter parameter set as a function of the result of the analysis from a plurality of filter parameter sets and to derive a control data set from the measurement data set with the obtained filter parameter set. In particular, the filter device filters measurement data less intensively when a more intensive relative movement of the connecting units with respect to one another occurs. A more intensive relative movement is understood to be a relatively rapid relative movement or a relatively rapid acceleration relative to one another or, if appropriate, also an absolute speed or acceleration. In contrast, in the case of a less intensive relative movement of the connecting units with respect to one another, filtering is carried out more intensively. This means stronger denoising is carried out on the measurement data or the value or the values of a measurement data set. As a result, a smoother time sequence can be made available.

The control device controls the damper device directly or indirectly by using further components such as (power) electronics and, in particular, by using a magnetic field-generating device. At any rate, the adjustment of the damping of the damper device is effected with the control data set.

Pre-processed data sets are obtained from the measurement data sets by pre-processing and/or by pre-filtering and/or by filtering, which pre-processed data sets are preferably used as the basis for further processing.

The measurement data sets are preferably measured with a frequency which is higher than 200 Hz or 500 Hz and, in particular, higher than 1 kHz. Both the current measurement data set and at least one preceding measurement data set or at least the current derived data set and/or at least one previously derived data set can be stored in the memory device. It is also possible and preferred for the respectively current control data set to be stored in the memory device.

Different options are produced for the respective pre-processing of the measurement data. During a first pass, a pre-set filter parameter set is preferably loaded and at least one first measurement data set is adopted. At first, a control data set with the pre-set filter parameter set is derived from the measurement data set.

Afterwards, according to a first variant a new or current measurement data set is adopted in a loop. Subsequently, a filter parameter set is selected or derived using the preceding control data set. A current control data set is derived with the filter parameter set which has been determined in this way. The damping of the damper device is adjusted taking into account this control data set or with this control data set.

During the next pass through the loop, the previously still current measurement data set becomes the preceding measurement data set. The current measurement data set is adopted. A filter parameter set is selected using the control data set of a preceding loop and, in particular, the last loop, and a current control data set is derived with the current measurement data set and the selected filter parameter set, and said current control data set is subsequently used to adjust the damping.

In an alternative method, after the first pass another loop can be run through. In this context, firstly a current measurement data set is also adopted. Using the current measurement data set, a filter parameter set is selected, and a current control data set is derived from the current measurement data set with the selected filter parameter set. Afterwards, the damping is adjusted taking into account the current control data set. The filter parameter set can also possibly be obtained iteratively. In this context, a renewed partial loop pass for obtaining the filter parameter set is carried out if the currently obtained control data set deviates from the preceding control data set by a certain degree or if the control data set or the values contained therein undershoot or exceed specific limits.

Furthermore, a further variant of the loop is possible according to which firstly a current measurement data set is adopted, and a current control data set is derived with the current measurement data set using the preceding filter parameter set. On the basis of the control data set, it is subsequently checked whether the correct filter parameter set has been selected. The filter parameter set is possibly newly selected, and a new control data set or current control data set is possibly newly derived. It is in turn also possible for checking as to whether the correct filter parameter set has been selected to take place here. This iteration loop can be carried out as frequently as desired. Preferably, the iteration loop is limited in its number in order to avoid a continuous loop. Finally, the damping is adjusted with the current control data set.

In one preferred development, a multiplicity of filter parameter sets are stored in the memory device, and a filter parameter set can be selected as a function of the at least one stored data set.

The stored data set can in all cases be the measurement data set in the form in which it is adopted. However, it is also possible for the acquired measurement data set to be pre-processed in a first pre-processing step with the sensor device, in order, for example, to obtain standardized values and subsequently store the data set obtained in this way in the memory device. A multiplicity of data sets which have been measured and pre-processed with one another are preferably stored in the memory device. Depending on the storage capability, an FIFO method can be selected, with the result that a number of the last measurement data sets remains in each case in the memory device.

In particularly preferred developments, the analysis device comprises a comparator device and the comparator device compares a stored data set with comparison data and selects, as a function of the result of the comparison, a filter parameter set stored in the memory device or derives a filter parameter set, and derives a control data set from the measurement data set with the filter parameter set. Such a configuration is very advantageous since very precise results can be achieved without complex computing operations.

A filter parameter set can preferably be selected as a function of the at least one stored data set. This means that a filter parameter set can be selected as a function of the content of at least one stored data set. Accordingly, a content of a stored data set can be compared with comparison data using the comparator device.

In all the configurations it is preferred that a multiplicity of data sets can be stored in the memory device. This includes not only the original measurement data sets but also the data sets derived therefrom and stored in the memory device, as well as the control data sets which can be stored in the memory device and, if appropriate, further similar data sets.

It is particularly preferred for the sensor device to be designed to acquire at least one travel signal. In advantageous developments, the control device is designed to derive a speed signal for a relative movement of the connecting units from a sensor signal (in particular of the sensor device). For this purpose, a computing unit is provided which can be part of the control device. The control device is preferably designed to derive an acceleration signal from a sensor signal (in particular of the sensor device). In particular, the control device is designed and configured to derive an acceleration signal of the required quality from a sensor signal. For this purpose, the control device determines the acceleration signal from the sensor signal at a frequency of preferably greater than 1 kHz. In order to calculate the acceleration signal, a computing unit which can also be part of the control device is also preferably provided. The same computing unit can be used to calculate the acceleration signal and the speed signal.

In the case of the damper device according to the invention and the method, the control of the damper device takes place, in particular, in real time. This means that damping such as is necessary and appropriate for the current load situation is set at any time. The damper device is not set to a suitable “average value” but instead at any time the sensor device is read out (periodically with 1 kHz or more), and speed signals and/or acceleration signals are acquired and derived, in particular, from travel signals. At any time, suitable damping for the current speed signal is now set in real time, since the damper device can be freely adjusted in a few milliseconds.

The control device is preferably designed to select a filter parameter set with relatively strong filtering in the case of speed signals and acceleration signals which are low in absolute value. The control device is preferably designed to select a filter parameter set with less filtering in the case of speed signals or acceleration signals which are relatively high in absolute value. This means that a filter parameter set with relatively strong filtering is selected if the speed signal and acceleration signal are small. A filter parameter set with relatively low filtering is selected even if only one of the two signals, specifically the speed signal and the acceleration signal, is greater. As a result, a very rapid reaction is ensured in the case of shocks, while stronger smoothing takes place in the case of small signals. However, when there is a strong shock, the reaction thereto is prevented from only occurring when it is (too) late.

Such rattling occurs, as has become apparent, in particular when the speed signal is below 10%, and more likely below 5% of the typical maximum speed signal during operation. If, in the event of a powerful shock, the maximum speed signal which occurs is, for example, approximately 0.5 m/s or 1 m/s, “scratching” can occur, in particular in the case of speed signals of up to 0.05 or 0.02 m/s. Here, in the case of speed signals which are below a predetermined limit, filtering is carried out more strongly, with the result that stronger denoising is carried out. In contrast, in the case of speed signals above the latter, filtering is carried out less strongly or not at all. However, if relatively large acceleration signals above a predetermined limit are obtained, the speed signal is filtered less intensively even in the case of a low absolute value. An optimum result is achieved by means of this combination. In the case of strong signals, little filtering (or none at all) is carried out, with the result that the speed signal is used (almost) directly to adjust the damping. This is advantageous, since in the case of such real-time damping (in the case of “real” shocks), any delay can be disadvantageous. In the case of slight shocks or vibrations which generate small speed signals and acceleration signals, stronger filtering, and in particular smoothing, is carried out. A delay is not particularly significant in the case of low loads.

The sensor device is advantageously suitable for acquiring, and designed to acquire, the travel signal with a resolution of better than 100 μm. The resolution of the travel signal can also be better than 50 μm or better than 30 μm and preferably better than 10 μm. With a sensor device which acquires travel signals with very high resolution, very precise control of the chassis can be carried out.

In particular, the sensor device is suitable for acquiring, and designed to acquire, the sensor signal with a measuring frequency of at least 500 Hz or at least 1 kHz. In this context, the measuring frequency can also reach or exceed 5 kHz.

In particularly preferred developments, the damper comprises not only the first damper chamber but also at least one second damper chamber. In this context, the first damper chamber and the second damper chamber are coupled to one another via at least the or an, in particular controllable, damping valve. The at least one damping valve or at least one damping valve is particularly preferably assigned at least one magnetic field-generating device which serves to generate and control a magnetic field in at least one damping duct of the damping valve. At least one magneto-rheological fluid or generally medium is particularly preferably provided in the damping duct. Using a magneto-rheological medium in the damping duct at least one property of the damper device can be adjusted individually and rapidly by actuating the magnetic field-generating device. Complete resetting of the damper force of the dampers or damping device can be carried out within a few milliseconds.

The method according to the invention serves to control the damping of a relative movement of two connecting units which can move relative to one another and between which at least one controllable damper with a damping valve with a magneto-rheological medium, fluid or damping fluid is provided for damping the relative movements. The at least one damping valve is assigned at least one magnetic field-generating device which serves to generate and control a magnetic field. Measurement data sets at least relating to a relative movement of the connecting units with respect to one another are acquired and pre-processed with a filter device. A derived data set comprises in particular (at least one value for) a speed signal and (at least one value for) an acceleration signal for a relative movement of the connecting units. At least one data set derived from an acquired measurement data set is stored in the memory device. At least one stored data set is analyzed, and a filter parameter set is determined as a function of the result of the analysis. In this context, a filter parameter set with relatively strong filtering is preferably selected in the case of speed signals which are low in absolute value and acceleration signals which are low in absolute value, and a filter parameter set with less filtering is preferably selected in the case of speed signals which are relatively high in absolute value or acceleration signals which are relatively high in absolute value. A control data set is derived from the measurement data set with the filter parameter set. The control device at least partially and, in particular, even completely controls the damper device with the control data set.

The method according to the invention also provides a large number of advantages, since it carries out pre-processing which is adapted as a function of the analysis of the measurement data, as a result of which suitable damping parameters are set at any time.

In preferred developments, at least one speed signal or speed data are derived from the measurement data set. At least one acceleration signal or acceleration data can likewise be derived from the measurement data set.

In preferred developments, a measurement data set or at least one value of a measurement data set is filtered more strongly when the absolute value of the respective value of the measurement data set is lower than when the absolute value of the value or values of the measurement data set is higher. In order to differentiate whether relatively strong or relatively weak filtering is carried out, it is possible to provide threshold values or a limiting value set. The values of the measurement data set can contain travel values, acceleration values and/or speed values. Filtering can also be understood to mean smoothing the values. The term “absolute value of the values” is understood to mean the mathematical absolute value—that is to say the value without a sign.

In particular, stronger filtering is carried out in the case of low speeds of the relative movement than in the case of high speeds. In this context, in particular the speed signal is taken into account in order to decide whether stronger or weaker filtering is to be carried out.

It is also preferred that stronger filtering is carried out in the case of low accelerations or acceleration signals of the relative movement than in the case of high accelerations or high acceleration signals.

The term “stronger” filtering is understood here to mean more intensive filtering. This means that more intensive denoising is carried out on more strongly filtered measurement data. This can take place, for example, by virtue of the fact that a larger number of preceding measurement data items are taken into account or by preceding measurement data being taken into account with higher weighting. Relatively strong filtering brings about stronger smoothing than relatively weak filtering. This gives rise to a lower cut-off frequency. Edges are rounder in the case of relatively strong filtering than in the case of relatively weak filtering during which the cut-off frequency is higher. Relatively strong filtering brings about, in particular, stronger denoising than relatively weak filtering. Speed signals and acceleration signals are particularly preferably taken into account in order to decide how strongly filtering will be carried out. If the speed signal exceeds a predetermined speed limit or if the acceleration signal exceeds a predetermined acceleration limit, weaker filtering is carried out than if the speed signal and acceleration signal are smaller than the respective limit.

It has been surprisingly found that in the case of high speed signals and/or high acceleration signals, significantly weaker pre-processing is necessary than in the case of low acceleration signals or low speed signals. In the case of high acceleration signals and/or speed signals which occur when obstacles are traveled over, low filtering or smoothing is sufficient or can be completely dispensed with. In contrast, in the case of small or very small shocks, mostly only a low acceleration and a low relative speed between the connecting units of the damper device occur. Here, noise is already produced in conjunction with a limited spatial and speed resolution and the digitization (i.e. the discretization of time and the discretization of values) of the measurement result owing to the principle, so that the measured values do not always bring about a satisfactory mode of operation of the damper device without further pre-processing. Raising the measuring frequency then even causes the noise to be increased, since in the case of higher measuring frequencies even smaller changes in value, which however have a comparable error, are obtained in each case between individual measurements. Therefore, any desired increase in the measuring frequency does not lead to an improvement in the measurement result but rather can be counter-productive, at any rate, if the resolution of the sensor device is not correspondingly also increased.

Since the invention relates to a damper device and a control method, in which the control of the damper takes place, in particular, in real time, the measuring frequency must be so high that at any time it is possible to react sufficiently quickly to any expected events. Therefore, when a shock occurs when for example traveling over, for example, a bump, a pothole, a root, or in the event of a jump, a damper device must react so quickly, and perform the appropriate damper adjustment, that in each case optimum, or at least sufficient, damping properties are brought about. Such time requirements generally do not occur nowadays e.g. in motor vehicles according to the prior art, since in said vehicles damping of a shock does not occur in real time or cannot occur in real time owing to the “slow” dampers, but rather as a maximum the general damper setting is changed. According to the invention, the damper setting of the damper device is adapted repeatedly during a shock, in order to obtain the respective optimum damper settings. Therefore, the measuring frequency and the regulator frequency of the control device must be correspondingly high, in order to implement the concept in the case of high dynamics.

At least a plurality of successively acquired data sets are preferably stored in the memory device. As a result, a plurality of previously acquired data sets can be accessed for the pre-processing of the current measurement data set. This permits, for example, sliding averaging or smoothing of the measurement data over a plurality of data sets, e.g. over 2, 3, 4, 5, 6, 8 or 10 data sets. As a result, a significant reduction in the digital noise and the noise overall is achieved.

In the case of particularly high measuring frequencies (e.g. 20 kHz or 50 kHz or 100 kHz or more), averaging of a certain number of measurements can also be carried out, and the mean value of a plurality of measurements (e.g. 2, 3 or 5 or 10) is output as a measurement data set. Such “oversampling” can be carried out using both software and hardware. What is important is that the output rate of the measurement data sets is sufficiently fast.

A strength or intensity of the smoothing preferably depends on the stored data set. In particular, a strengthening of the smoothing depends on the current data set. It is possible and preferred here that, for example in the case of sliding averaging, the number of data sets used for the averaging is varied. If, for example, relatively strong filtering is desired, the smoothing can be carried out over a correspondingly larger number of successively adopted data sets, while in the case of relatively weak filtering a correspondingly smaller number of data sets are taken into account for the averaging.

It is also possible and preferred that the proportional factors for smoothing averaging are varied as a function of the strength of the desired filtering. In the case of relatively strong filtering, for example, adjacent or preceding measured values can be taken into account with the same weighting or similar weighting as the current measured value. For example, for relatively strong filtering, 20% of the current measured value and the preceding 4 values (or respectively 10% of the current measured value and the preceding 10 values) can be taken into account. In contrast, in the case of relatively weak filtering (fewer measured values and) measured values which are spaced further apart in terms of timing can be taken into account with a lower proportional factor. For example, in the case of relatively weak filtering 75% of the current measured value and 25% of the preceding measured value can be taken into account. Alternatively, respectively 50% of the current measured value and of the one before it is taken into account, while in the case of relatively strong filtering the current measured value and the two measured values before it are respectively taken into account with the same weighting (33%).

In addition to filtering over sliding average values, IIR (Infinite Impulse Response) filters or FIR (Finite Impulse Response) filters or other filters can also be used. The use of a Kalman filter is also preferred, in which case at least one parameter of the Kalman filter is then varied with the strength of the filtering.

In all configurations, it is particularly preferred if the sensor device is used to acquire measurement data sets with a measuring frequency of higher than 250 Hz (in particular 500 Hz and preferably 1 kHz) and/or the control device determines control data sets with a control frequency of higher than 250 Hz (in particular 500 Hz and preferably 1 kHz). The damper device is preferably at least temporarily actuated with at least this control frequency of 250 Hz (in particular 500 Hz and preferably 1 kHz). The measuring frequency and the control frequency are particularly preferably each >2 kHz. The measuring frequency and/or the control frequency are preferably higher than 5 kHz.

The sensor device particularly preferably acquires travel signals with a resolution of less than 100 μm or less than 50 μm. Preferably, a resolution of less than 30 μm and particularly preferably less than 10 μm is achieved. As a result, high-resolution relative movements can be determined, which increases the accuracy.

In all configurations, it is particularly preferred if the measuring frequency and the control frequency are at least temporarily higher than 8 kHz and the resolution of the travel signals is at least temporarily less than 10 μ or 5 μ. In this context, it is particularly preferred if the measuring frequency is less than 50 kHz and preferably less than 20 kHz or if the outputting of measurement data sets takes place at a frequency of less than 50 kHz and preferably less than 20 kHz.

It is also possible and preferred that the measuring frequency and the control frequency are different. The measuring frequency is preferably higher than the control frequency. The control frequency is preferably higher than 50 Hz and, in particular, higher than 100 Hz and preferably higher than 250 Hz or higher than 500 Hz. The measuring frequency is, in particular, higher than 250 Hz and preferably higher than 500 Hz and particularly preferably higher than 1 kHz. A ratio of the measuring frequency to the control frequency can be higher than 2 and, in particular, higher than 4 and preferably higher than 8 or 16.

Overall, the invention makes available an advantageous method and an advantageous damper device, as a result of which an adapted and respectively smooth response behavior is made possible in all load ranges. Surprisingly, the desired result was not obtained by increasing the measuring frequency but rather by analyzing the respective measured values and by carrying out filtering as a function of the respective measured values. It has in fact been found that the recording of measured values was previously not too slow but rather too fast in the case of low damper speeds, since, also owing to the inevitably occurring noise, which is caused at least partially also by digitization effects, the relative errors increase as the measuring frequency increases at low rates of change of the measurement variables, for which reason the damper device adjusted the noisy values too quickly owing to its high reaction speed. In contrast, in the case of particularly strong shocks, the measured values change from one step to the next with such a speed that no appreciable errors are introduced as a result of the digitization.

In one variant, a damper device according to the invention comprises two connecting units which can move relative to one another and between which at least one controllable magneto-rheological damper is provided for damping relative movements such as e.g. shocks or oscillations. At least one control device and at least one memory device are provided. At least one sensor device is provided for acquiring measurement data sets relating at least to a relative movement of the connecting units with respect to one another. A filter device is provided for pre-processing the measurement data sets. At least one data set, derived from a measurement data set acquired with the sensor device during the relative movement of the connecting units which can move relative to one another, can be stored in the memory device. An analysis device is provided which is designed and configured to analyze at least one stored data set and to determine a filter parameter set as a function of the result of the analysis and to derive a control data set from the measurement data set with the filter parameter set, with the result that the control device controls the damper device at least partially or even completely with the control data set. Developments contain some or all of the features of the damper device described above.

It has also proven advantageous to increase the measuring accuracy and/or the measuring resolution. It is particularly advantageous to adapt the measuring resolution and measuring frequency to one another and filter the measurement data after analysis of the measurement data. In this context, the evaluation takes place in real time.

In all the refinements, it is preferably possible that the filter device is integrated into the control device. The filtering can be carried out at least partially or completely by means of a computing unit of the control device.

Further advantages and features of the present invention are apparent from the exemplary embodiments which are explained with reference to the appended figures.

In the Figures:

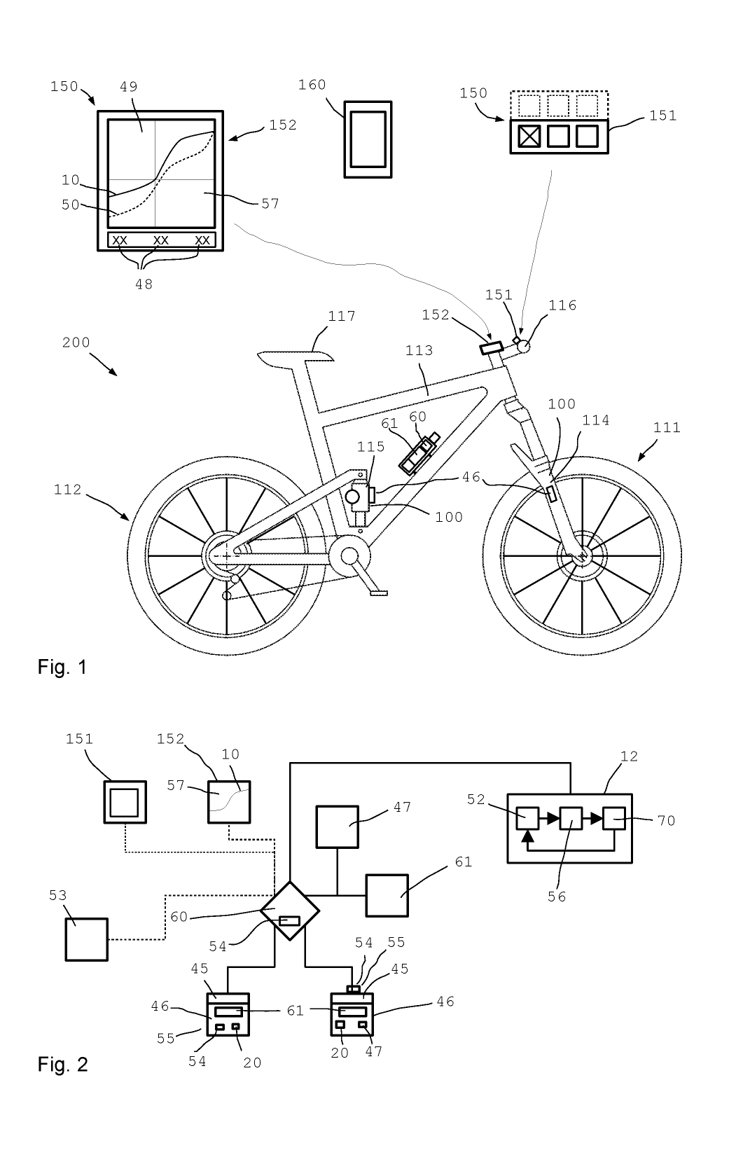

FIG. 1 shows a schematic illustration of a bicycle with a damper device according to the invention;

FIG. 2 shows a schematic illustration of the control of the damper device according to FIG. 1;

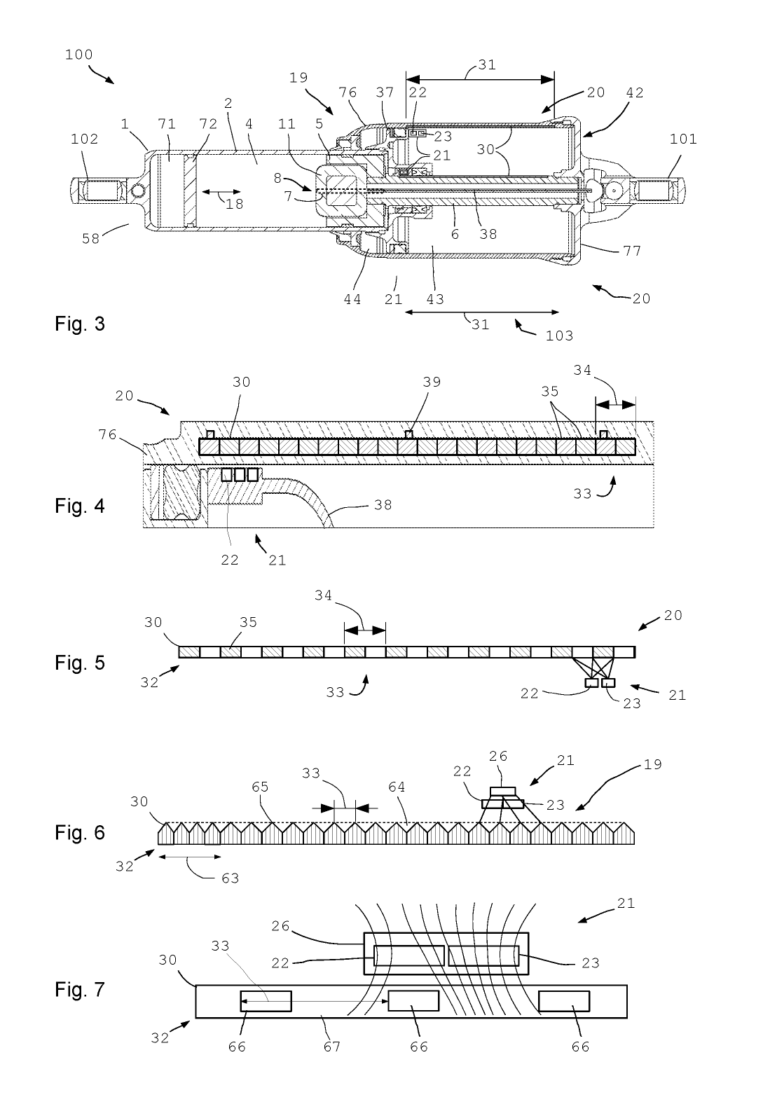

FIG. 3 shows a schematic sectional illustration of a further damper device e.g. for the bicycle according to FIG. 1;

FIG. 4 shows the sensor device of the damper device according to FIG. 3 in an enlarged illustration;

FIG. 5 shows an alternative sensor device for the damper device according to FIG. 3;

FIG. 6 shows a further sensor device for the damper device according to FIG. 3;

FIG. 7 shows yet another sensor device for the damper device according to FIG. 3;

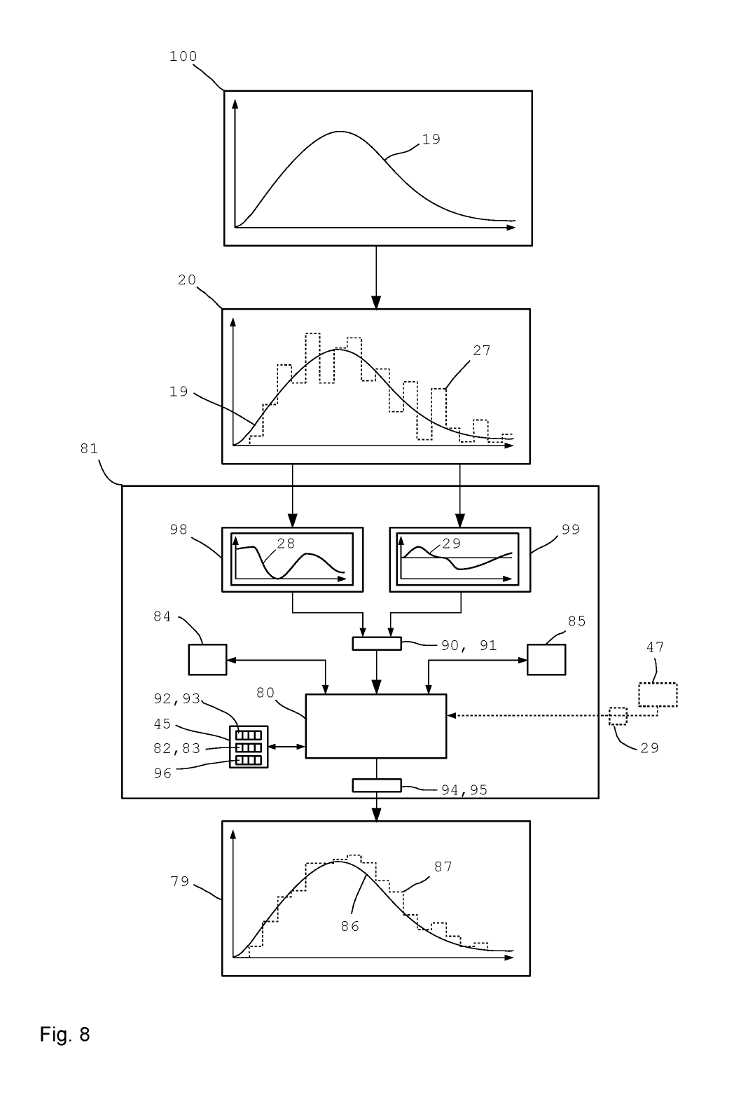

FIG. 8 shows a schematic illustration of the data pre-processing of the data measured with the sensor device; and

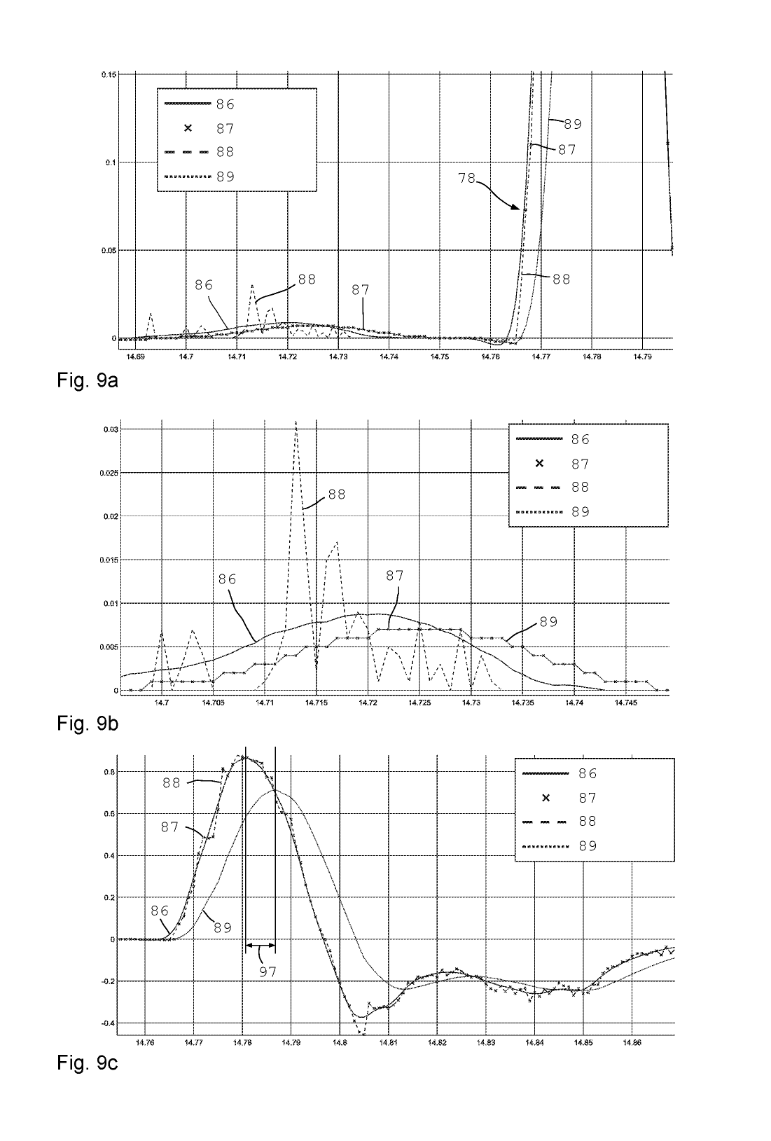

FIGS. 9a to 9c show real measurement data of the damper device according to FIG. 3.

Exemplary embodiments and variants of the invention relating to a damper device 100 with a damper 1 are described with reference to the appended figures. The damper device 100 is used here on a bicycle 200.

FIG. 1 shows a schematic illustration of a bicycle 200 which is embodied here as a mountain bike and has a frame 113 and a front wheel 111 and a rear wheel 112. Both the front wheel 111 and the rear wheel 112 are equipped with spokes and can have the illustrated disk brakes. A gearshift serves to select the transmission ratio. Furthermore, the bicycle 200 has a steering device 116 with handlebars and a saddle 117.

The front wheel 111 has a damper device 100 which is embodied as a suspension fork 114, and a damper device 100 which is embodied as a rear wheel damper 115 is provided on the rear wheel 112.

The damper device 100 comprises, in the simplest case, a damper 1 and a control device 46. It is also possible for the damper device 100 to comprise two dampers 1 (suspension fork and rear wheel shock absorber), on each of which a control device 46 is provided. Alternatively, the damper device 100 comprises two dampers 1 and a (central) control device 60. The (central) control device 60 can be used to make the pre-settings and to coordinate the two dampers.

The central control device 60 is provided here together with a battery unit 61 in a drinking bottle-like container and is arranged on the lower tube, where otherwise a drinking bottle is arranged, but can also be arranged in the frame. The central control device 60 can also be arranged on the handlebars 116.

The dampers 1 and further bicycle components can be controlled as a function of a wide variety of parameters and are essentially also controlled on the basis of data acquired by sensor. In particular, ageing of the damping medium, of the spring device and of further components can also be taken into account. It is also preferred to take into account the temperature of the damper device 100 or of the damper 1 (suspension fork 114 and/or rear wheel shock absorber 115).

The damper device 100 and its central control device 60 are operated by means of operator control devices 150. Two operator control devices 150 are provided, specifically an activation device 151 and an adjustment device 152. The activation device 151 has mechanical input units 153 at the lateral ends or in the vicinity of the lateral ends of the handlebars 116. The adjustment device 152 can be embodied as a bicycle computer and can have a touch-sensitive screen and also be positioned on the handlebars 116. However, it is also possible that a smart phone 160 or a tablet or the like is used as the adjustment device 152 and is stored, for example, in the user's pocket or backpack if the settings are not changed.

The display 49 is embodied, in particular, as a graphic operator control unit or touchscreen 57, and the user can therefore touch, for example, a displayed damper characteristic curve 10 with his fingers and change it by dragging movements. As a result, on the basis of the continuous damper characteristic curve 10 which is displayed it is possible to generate the damper characteristic curve 50 which is also displayed and which is then used immediately for the control. It is also possible to change the damper characteristic curves 10, 50 while traveling.

The adjustment device 152 can also serve as a bicycle computer and display information about the current speed as well as about the average speed and/or the kilometers per day, kilometers for a tour or round and the total number of kilometers. It is also possible to display the current position, the instantaneous altitude of the section of route being traveled on and the route profile as well as a possible range under the current damping conditions.

FIG. 2 shows a schematic illustration of the control of the damper device 100 and of the communication connections of a number of components which are involved. The central control device 60 can be connected in a wire-bound or wireless fashion to the individual components. For example, the control device 60 (or 46) can be connected to the other components via WLAN, Bluetooth, ANT+, GPRS, UMTS, LTE or other transmission standards. If appropriate, the control device 60 can be connected in a wireless fashion to the Internet 53 via the connection illustrated by a dotted line.

The control devices 46 and/or 60 are connected to at least one sensor device 20 or to a plurality of sensors. The control device 60 is connected to control devices 46 of the dampers 1 on the front wheel and on the rear wheel via network interfaces 54 or radio network interfaces 55. The control device 46 which is possibly provided on each damper 1 performs the local control and can have, in each case, a battery or else be connected to the central battery unit 61. It is preferred that both dampers are controlled via the control device 60. It is also possible for the dampers 1 to be controlled locally by means of assigned control device 46.

Each damper 1 is preferably assigned at least one sensor device 20 in order to detect relative movements between the components or connecting units 101 and 102. In particular, a relative position of the components 101 and 102 relative to one another can be determined. The sensor device 20 is preferably embodied as a (relative) travel sensor or comprises at least one such sensor and is integrated into the damper 100. It is also possible and preferred to use at least one additional acceleration sensor 47. The sensor device 20 can also preferably be embodied as a speed sensor or comprise such a sensor.

After the determination of a characteristic value for the relative speed, the associated damping force and an appropriate spring force are set on the basis of the damper characteristic curve 10, stored in the memory device 45, of the damper 100. A suitable spring force can be determined by means of the weight of the rider. For example, the rider's weight can be derived by automatically determining the spring compression position (sag) after a rider gets on. A suitable air pressure in the fluid spring or gas spring can be inferred from the spring compression travel when the rider gets on the bicycle, which pressure is then adjusted or approximated automatically, immediately or in the course of operation.

FIG. 2 is a schematic illustration of the control circuit 12 which is stored in the memory device 45 and stored or programmed in the control device 46 or 60. The control circuit 12 is carried out periodically and, in particular, in a continuously periodic fashion, during operation. In step 52, a current relative movement or relative speed of the first component or connecting unit 101 with respect to the second component or connecting unit 102 is detected with the sensor device 20. In step 52, a characteristic value which is representative of the current relative speed is derived from the values of the sensor device 20. A relative speed is preferably used as the characteristic value.

The damper 1 (cf. FIG. 3) has a first and a second damper chamber between which a damping valve 8 is arranged. The damping valve 8 has at least one damping duct 7 which is subjected to a magnetic field of an electrical coil device, in order to influence the magneto-rheological medium or fluid (MRF) in the damping duct 7 and in this way set the desired damping force. A damper characteristic curve is taken into account during the setting of the damping force.

In step 56, the associated damping force which is to be set is then subsequently derived from the current measured values while taking into account the predetermined or selected damper characteristic curve. A measure of the field strength or current strength which is to be currently set, and with which the damping force which is to be set is at least approximately attained, is derived therefrom. The measure can be the field strength itself or else, e.g., indicate the current strength with which the damping force to be set is at least approximately attained.

In the following step 70, the field strength which is to be currently set is generated or the corresponding current strength is applied to the electrical coil device 11 as a field-generating device, with the result that the damping force which is provided with the selected or predetermined damper characteristic curve for the current relative speed of the first connecting unit 101 with respect to the second connecting unit 102 is generated within an individual cycle or a time period of the control circuit 12. Subsequently, the next cycle starts, and step 52 is carried out again. Each cycle requires, in particular, less than 30 ms and, in particular, less than 20 ms. It is possible that the acquisition of the sensor data and the subsequent calculations are carried out at a relatively high speed (e.g. an, in particular, integral multiple of the measuring frequency).

FIG. 3 shows an exemplary embodiment of a damper device 100 with a damper 1 and here with a spring device 42, which is embodied as an air spring and comprises a positive chamber 43 and a negative chamber 44. The damper 1 is attached by the first end as component 101 and the second end as component 102 to different parts of a supporting device 120 (in this case to a vehicle) in order to provide damping of relative movements. The damper 1 comprises a first damper chamber 3 and a second damper chamber 4 which are separated from one another by the damping valve 8 which is embodied as a piston 5. In other configurations, an external damper valve 8 is also possible, said damper valve 8 being arranged outside the damper housing 2 and being connected via corresponding feed lines.

The piston 5 is connected to a piston rod 6. The magneto-rheological damping valve 8 (indicated by dashed lines) is provided in the damping piston 5, said damping valve 8 comprising here an electrical coil 11 as a field-generating device, in order to generate a corresponding field strength. The damping valve 8 or the “open state” of the damping valve is actuated by means of the electrical coil device 11.

The coil of the electrical coil device 11 is not wound around the piston rod 6 in the circumferential direction but rather about an axis extending transversely with respect to the longitudinal extent of the piston rod 6 (and parallel to the plane of the drawing here). A relative movement takes place here linearly and occurs in the direction of movement 18. The magnetic field lines run here in the central region of the core approximately perpendicularly with respect to the longitudinal extent of the piston rod 6 and therefore pass approximately perpendicularly through the damping ducts 7. A damping duct is located behind the plane of the drawing and is indicated by dashed lines. This brings about effective influencing of the magneto-rheological fluid located in the damping ducts 7, with the result that the flow through the damping valve 8 can be damped effectively.

An equalization piston 72, which disconnects an equalization space 71 for the volume of the piston rod, which enters when spring compression occurs, is arranged in the damper housing 2.

Not only in the damping valve 8 but also here in the two damping chambers 3 and 4, there is a magneto-rheological fluid present everywhere here (with the exception of the equalization space 71) as a field-sensitive medium. A gas or gas mixture is preferably present in the equalization space 71.

The damper device 100 has a sensor device 20. The sensor device 20 comprises in each case a detector head 21 and a scaling device 30 embodied in a structured fashion.

The scaling device 30 comprises here a sensor belt with permanent magnetic units as field-generating units. The poles of the permanent magnetic units alternate with the result that north and south poles are arranged in alternating fashion in the direction of movement of the detector 22. The magnetic field strength is evaluated by means of the detector head, and the respective current position 19 is determined therefrom. The design and function of the sensor device 20 will be explained in more detail below.

For the sake of better clarification, two different variants of a sensor device 20 are shown in FIG. 3. In both variants, the sensor device 20 is arranged inside a housing of the damper device 1 or is surrounded radially by a housing 2 or 76 of the damper device on at least one longitudinal section. This means that the sensor device 20 is arranged at least partially within the external circumference of the spring housing 76 and/or within the external circumference of the damper housing 2.

The spring device 42 extends here at least partially around the damper housing 2 and comprises a spring housing 76. One end of the damper 1 is connected to a suspension piston 37 or forms such a suspension piston 37. The suspension piston 37 separates the positive chamber 43 from a negative chamber 44. The damper housing 2 with the first damper chamber 3 dips into the spring housing 76 or is surrounded thereby. Depending on the spring compression state, the spring housing 76 also at least partially surrounds the second damper chamber.

The spring housing 76 is closed off with respect to the end of the connecting unit 101 by a cover 77. The connecting cable 38 for the electrical coil device 11 is also led out there. An electrical connecting cable for the sensor device 20 is also preferably led to the outside there.

The sensor device 20 comprises two sensor parts, specifically the detector head 21, which in the variant illustrated above here is arranged inside the positive chamber 43 of the spring device 42. The sensor device 20 comprises as a further sensor part the scaling device 30 which in this variant is arranged or held in the spring housing 76. Depending on the configuration and selection of material of the spring housing 76 and depending on the measuring principle of the sensor device 20, the scaling device 30 can be integrated into the wall of the spring housing 76 or else arranged on the inner wall of the spring housing 76.

It is also possible for the scaling device 30 to be inserted into a longitudinal groove on the outer wall of the spring housing 76. This is possible e.g. if the sensor device is based on the evaluation of magnetic field strengths or uses magnetic field strengths and if the spring housing 76 is composed, for example, of a composite fiber material or of some other magnetically non-conductive material.

In the other illustrated variant, the scaling device 30 is integrated, for example, into the piston rod. The scaling device 30 can e.g. be inserted into a groove in the piston rod 6. The piston rod 6 is preferably composed of a magnetically non-conductive or poorly conductive material.

In both alternatives, the detector head 21 comprises two detectors 22 and 23, which are arranged offset with respect to one another in the direction of movement 18 here. In the first alternative, the detector head 21 is arranged on the suspension piston 37 and, in particular, attached thereto. In the first alternative, the detector head 21 is seated radially further outward adjacent to (but spaced apart from) the scaling device 30 in the spring housing 76. In the second alternative, the detector head 21 is arranged radially further inward on the suspension piston 37.

In every case, the scaling device 30 has a structure 32 which extends over a measuring section 31 and over which the physical properties of the scaling device 30 change periodically.

Sensor sections 33 (cf. FIGS. 4 to 7) are preferably arranged on the scaling device 30 and have electrical and/or magnetic properties which respectively repeat and therefore form the structure 32 of the scaling device 30.

In this context it is possible, as already illustrated in FIG. 4, for the scaling device 30 to have a multiplicity of permanent magnets whose poles are arranged in an alternating fashion, with the result that a north pole and a south pole alternate with one another.

In such a configuration, the detector head 21 is equipped with detectors 22 and 23 which detect a magnetic field. For example, the detectors 22 and 23 can be embodied as electrical coils or, for example, be configured as Hall sensors in order to detect the intensity of a magnetic field of the permanent magnets.

If a relative movement of the connecting units 101 and 102 of the damper 1 with respect to one another now takes place, the position 19 of the damper 1 changes and the relative position of the detector head 21 relative to the scaling device 30 shifts. By evaluating the signal strength of a detector 22, 23 and, in particular, of at least two detectors 22, 23 it is therefore possible to infer the relative position of the detector head 21 relative to a sensor section 33 or with respect to the scaling device 30 or the absolute position within a sensor section 33. If two detectors are arranged offset with respect to one another in the direction of movement 18 and if both detectors detect the magnetic field of the scaling device 30, the position 19 and the direction of movement 18 can be determined very precisely by evaluating the signals.

During the continuous movement, the number of sensor sections or periods passed is stored in the memory device 45 of the control device 46, with the result that the absolute position 19 can be inferred. All that is required for this is for the measuring frequency to be so high that a complete sensor section is not moved past “unnoticed” during a measuring cycle.

By determining the intensity of the field strength it is possible to increase the resolution of the sensor device 20 considerably. In this context it is possible for the resolution for the determination of the position 19 to be smaller than a length 34 of a sensor section 33 by a factor of 50, 100, 500, 1000, 2000, 4000 or more. Factors which correspond to a power of 2, for example 128, 256, 512, 1024, 2048, 4096, 8192, 16384 or more are particularly preferred. This facilitates the (digital) processing of signals. As a result, when a structure 32 with sensor sections 33 in the millimeter range is used, a resolution in the micrometer range can be achieved.

The sensor device 20 can comprise permanent magnets as field-generating units 35 on the scaling device 30, as illustrated in FIG. 4. However, it is also possible that the structure 30 does not generate a permanent magnetic field but rather other physical and, in particular, magnetic and/or electrical properties change over the length of the structure 32.

For example, the scaling device 30 can be formed at least partially from a ferromagnetic material, wherein the scaling device 30 has, for example at regular or predetermined intervals, on the ferromagnetic material, prongs, teeth, projections, grooves or other structures which can be used for determining positions. It is also possible for the scaling device to be composed, for example, in its entirety from an insulator or non-conductor 67 into which conductors 66 are embedded at periodic intervals. Various measuring principles of the sensor device 20 are explained below with reference to FIGS. 4 to 7.

In FIG. 4, a variant of the sensor device 20 is shown in which the structure 30 has permanent magnets as field-generating units 35. In this context, the poles of the field-generating units 35 are preferably arranged in an alternating fashion with the result that a magnetic field which changes periodically is produced over the measuring section 31 of the scaling device 30.

In FIG. 4, the detector head 21 is arranged in the interior of the housing 76, and the scaling device 30 is located integrated into the damper housing 2 or spring housing 76 or some other housing. Position marks 39 or the like are provided at specific intervals in order to make available specific calibration points for the calibration of the absolute position or else to permit absolute determination of positions by means of specific encoding operations. Separate end position sensors can also be provided in all cases.

The scaling device 30 can be composed of individual permanent magnets or embodied as a single magnet with alternating magnetization. A magnetic strip, made, for example, from plastic-bound magnetic material, is preferably used as the scaling device 30.

The scaling device 30 can be, in particular, part of the housing 2 or 76 or of some other part of the damper 1 if this part is composed at least partially from a material with hard magnetic properties. In this case, the relative, and in certain designs also absolute, determination of positions can be carried out by means of locally different magnetization of the material.

One preferred embodiment provides for the scaling device 30 to be applied in the form of a hard magnetic coating to the housing 2 or 76 etc. In this context, layer thicknesses of less than 1 mm or less than 100 μm and, in particular, less than 10 μm can be achieved and are sufficient for the determination of positions.

FIG. 5 shows a variant in which permanent magnets 35 are also arranged at regular intervals on the scaling device 30. For example, in each case a non-magnetic material is provided between the permanent magnets 35. This too results in a periodically changing intensity of the magnetic field over the measuring section 31 of the scaling device 30. A detector head 21, also with two detectors 22, 23 here, is shown in a highly schematic form, wherein the detection angle is shown for the two detectors, in order to clarify that different intensities during the measurement are obtained with these detectors 22, 23 which are arranged offset in the direction of movement 18.

FIG. 6 shows another configuration of the sensor device 20, wherein the structured scaling device 30 is, for example, embodied in a ferromagnetic fashion and does not make available a separate magnetic field, or essentially makes no such field available. Here, the outer shape of the ferromagnetic part of the scaling device 30 is provided with a regular structure, wherein tips 65 or prongs or other projections or depressions are provided at regular and/or predetermined intervals. The length 34 of a sensor section 33 is obtained here from the distance between two tips 65 or prongs or the like. In order to make available a smooth surface, the intermediate space between the tips 65 can be filled with a filler material 64.

In this variant, the detector head 21 preferably comprises in turn two magnetic field sensors or detectors 22 and 23. In addition, a magnetic field-generating device 26 is provided in the form of, for example, a permanent magnet. The magnetic field of the magnetic field-generating device 26 is influenced or “bent” by the structure 32 of the scaling device 30, with the result that different field strengths of the magnetic field of the magnetic field-generating device 26 are produced here too as a function of the position of the individual detectors 22 and 23, which field strengths are detected by the detectors 22, 23. The detectors 22, 23 can also be embodied here, for example, as electrical coils or Hall sensors or the like.

At this point it is noted that in all configurations and exemplary embodiments the structure 32 of the scaling device 30 does not necessarily have to have the same lengths 34 of the sensor sections 33 over its entire length. It is also possible for some of the sensor section 33 to have, for example, relatively short (or relatively long) sensor sections in one section 63. It is also possible for each individual sensor section 33 to have a different length. Different lengths of the sensor sections 33 can be appropriate, for example, in order to bring about automatically a higher resolution in the vicinity of an endpoint. Conversely, in other regions a relatively large distance or relatively large length of a sensor section 33 may be provided in order to make the sensor device 20 less sensitive there.

One preferred embodiment provides for the scaling device 30 to be configured in such a way that two or more parallel paths, which act as individual scales, run in the direction of movement 18. In this context, individual scales do not have to act uniformly over the entire length of the movement, for example when they are used as an index at the ends. The detector head 30 is then correspondingly configured and has at least one additional detector 22.

In this context, the position of the detector head 30 can also be determined absolutely by using two or more paths in the scaling device 30: either by means of digital encoding or else two paths with differing lengths of the respective sensor sections 33, similarly to the nonius in the case of calipers.

FIG. 7 also shows a configuration of a sensor device 20 in which the scaling device 30 does not have any magnetic parts here. The scaling device 30 has again a structure 32, wherein conductors 66 are inserted here at periodic intervals into a material which is non-conductive per se or an insulator or a non-conductor 67. A length 34 of a sensor section 33 is also determined here by means of the distance between two conductors 66.

The detector head 21 has in this exemplary embodiment a magnetic field-generating device 26 which is designed to make available a magnetic alternating field. Furthermore, the detector head has at least one detector and, in particular, at least two detectors 22, 23 which are used in turn to detect magnetic fields or the intensity of magnetic fields.

In the case of the sensor device 20 in the exemplary embodiment according to FIG. 7, the magnetic field-generating device 26 generates an, in particular high-frequency, magnetic alternating field. As a result, eddy currents are generated in the conductors 66 and they in turn induce in the conductors 66 magnetic fields which are directed counter to the exciting magnetic field. As a result, the magnetic field is expelled from the conductors 66 and amplified between the conductors 66, with the result that in the illustration according to FIG. 7 the detector 23 receives a stronger signal than the detector 22. In the case of a further relative shift of the detector head 21 relative to the scaling device 30, the magnetic conditions change as a function of the position, with the result that the position 19 can be derived by means of the signals of the detectors 22, 23. Furthermore, it is also possible to infer the direction of movement 18.

The measured values which are obtained by means of the sensor device 20 are pre-processed according to the sequence illustrated in FIG. 8, in order to control at least one damper 1 therewith.

The damper 1 experiences spring compression in the event of shocks, with the result that the position 19 of the connecting units 101, 102 relative to one another changes correspondingly. The sensor device 20 operates primarily as a travel sensor and derives a corresponding signal profile of the sensor signals 27 from the time profile of the position 19. In this context, the signal is digitized and already experiences digitization noise as a result. Furthermore, other effects can also contribute to the production and/or increase of the noise. Unsuitable filtering can also amplify the noise. Therefore, a suitable algorithm is important.

After the detection of the travel signal as sensor signal 27, the travel signal 27 of the speed signal 28 is differentiated in a computing unit 98 in order to obtain said speed signal 28. In addition, in a computing unit 99 for determining an acceleration signal 29 either the travel signal 27 can be derived twice or the speed signal 28 is derived once in order to obtain the acceleration signal 29.

The speed signal 28 and the acceleration signal 29 form together a measured value data set 90, or a measured value data set 91 at the next pass. The measured value data sets are fed to a filter device 80 and can be stored directly in a memory device 45. The measured value data sets 90, 91 are analyzed successively in the filter device 80. The measured value data sets can also be analyzed in parallel. A corresponding filter parameter set 82 or 83 etc. is selected or derived as a function of the values of a measured value data set 90. For this purpose, a comparison of at least one value of the measured value data set 90 can be made with the associated limiting value from the limiting value set 96. If the value of the measured value data set 90 exceeds the associated limiting value of the limiting value set 96, e.g. a filter parameter set 82 is selected, and otherwise a filter parameter set 83. Subsequently, a control data set 94 is derived from the measured value data set 90 with the correspondingly determined filter parameter set 82, 83 using a suitable filter algorithm.

It is possible and preferred that in the case of a measurement data set 91 the filter parameter set is determined with the preceding measurement data set 90, since owing to the high measuring frequency it is assumed that from one measurement data set to the next measurement data set the values do not change to such an extent that it is necessary to re-determine a filter parameter set.

However, it is also possible and preferred that a measurement data set 91 (or previously 90) is stored in a pre-processed form or in a direct, non-pre-processed form in the memory device 45 as a stored data set 93. A filter parameter set 82, 83 can be selected with the data set 93 which is now stored. Using the filter parameter set, a corresponding control data set 95 can be calculated with the corresponding filter, for example a Kalman filter 84 or an average value former 85 or some other filter algorithm or with other filter devices.

After the calculation of the control data set 95, it can be iteratively checked whether the associated filter parameter set was the correct filter parameter set. In any case or in some cases or when certain deviations are exceeded, renewed determination of a suitable filter parameter set can be carried out in order thereby subsequently to derive the current control data set 95 again. Such iteration can take place once or can be carried out repeatedly and can be limited to a maximum number of passes.

In addition, an acceleration signal 29 of a separate acceleration sensor 47 can also be fed to the filter device. Therefore, the acceleration of the two-wheeled vehicle can also be taken into account overall.

During the determination of a suitable filter parameter set 82, 83, it is possible that two or more different filter parameter sets 82, 83 are provided, wherein the selection of a filter parameter set 82, 83 preferably takes place according to whether the speed signal exceeds a specific value or not. In addition, it is possible and is particularly preferred also to use the acceleration signal to decide about a suitable filter parameter set. In the exemplary embodiment, both the speed signal and acceleration signal are used to select a suitable filter parameter set.

In simple cases, filtering is carried out by forming average values, wherein different filter parameter sets can differ by virtue of the fact that the number of measured values taken into account is varied. If, for example, low speed signals and low acceleration signals are present, more measured values can also be taken into account from the past than in the case of high speed signals or high acceleration signals, since otherwise in the case of high speeds and high accelerations a significant and, under certain circumstances, damaging delay can occur during the reaction of the damper 1. Conversely, relatively strong smoothing of measured values in the case of low speed signals and low acceleration signals causes digitization noise to be filtered out more strongly, as a result of which the response behavior remains clean even in the case of small and very small shocks.

Finally, at the bottom of FIG. 8 is a diagram 79 in which the real speed 86 and the speed 87 used for control are plotted schematically. The deviations between the curves are small as a result of the analysis of the measured values and the corresponding consideration of a filter parameter set.

A Kalman filter is particularly preferably used in all the configurations. The filter parameter set is determined for the preferred Kalman filter as follows:

The (noisy) measured speed “Vr” and the (noisy) measured acceleration “Ar” of the connecting units with respect to one another are transferred to the filter algorithm here. The values for Vr and Ar are measured by the sensor device 20 or derived therefrom. The speed signal and the acceleration signal can be derived from the sensor signal. The acceleration signal can also be determined directly by means of a separate acceleration sensor 47.

The estimated or derived speed “Vg” (reference symbol 87) and, if appropriate, the estimated acceleration “Ag” of the relative movement of the connecting units are determined from the above using the Kalman filter. Here, the values Vr and Ar are specified in SI units and consequently in “m/s” and “m/s2”, respectively.

At first, variables “Q0” and “R” and “Vg” and “P” are defined. At the first pass of the filter algorithm, starting values are defined, here preferably Q0=0.01 and R=5 and Vg=0 and P=1 are set. Vg corresponds to the estimated or derived speed 87 of the relative movement of the connecting units with respect to one another, said speed 87 being used for the determination of the damping.

Subsequently, at each pass the filter parameter set is determined, and values are determined for Q, Pp, K, Vg and P. The parameters of the filter parameter set 82, 83 depend on the measured (noisy) values. In this respect, it is discerned whether the mathematical absolute value of the acceleration “Ar” which is measured (with noise) is larger than a predefined threshold value, preferably 5 here. The speed “Vg” which is estimated or derived in the previous pass (from the stored data set 92) is defined as a value Vp by means of Vp=Vg (from the last loop).

Furthermore, it is determined whether the mathematical absolute value of the value Vp (estimated speed Vg of the relative movement of the connecting units with respect to one another in the last pass) is higher than a further threshold value, preferably 0.1 here.

Even if only one of the conditions applies, the parameter “Q” is set to a predefined value, here Q=2. If no condition applies, Q is set to another predefined value, specifically here to Q=Q0 and therefore to Q=b 0.01.

After this, values Pp, K, Vg and P are determined as

Pp=P+Q.

K=Pp*1/(Pp+R)

Vg=Vp+K*(Vr−Vp)

P=(1−K)*Pp.

An estimated speed “Vg” (reference symbol 87 in FIG. 8) is fed back as a result of the filter algorithm or the filter function. An estimated acceleration “Ag” can also be determined and fed back. The filter parameters and calculated values are stored as a filter parameter set 83 at least up to the next pass. At the next pass, the filter parameter set 83 becomes the filter parameter set 82.

The speed 87 is then used for control.

Finally, real values which have been recorded with the damper according to FIG. 4 are plotted in FIGS. 9a to 9c.

In this context, FIG. 9a shows the time sequence over somewhat more than one 10th of a second, within which initially only very low speeds are present, while a relatively large shock occurs toward the end of the displayed time period.

The real speed 86, which was also determined by means of additional sensors and which was subsequently determined in a costly fashion after the measurement, is shown by a continuous line. In the normal travel mode, the real speed 86 is not available with the measuring quality for the control. The real speed 86 is presented here only for the purpose of comparison.

The dashed line 88 shows the speed 88 which was filtered with a first filter parameter set 82 and at the start of the illustrated measuring time period deviates considerably from the real speed 86.

The dotted line 89 shows the speed profile which was determined with a second filter parameter set 83 with relatively strong filtering. At the start of the measuring time period, the curve 89 shows a considerably smoother profile than the curve 88 illustrated by a dashed line. The deviations from the profile of the real speed 86 are relatively small. Although a slight time offset can be seen, it is not significant in the case of these small shocks.

At the start of a relatively strong shock at approximately 14.76 seconds, the profile of the real speed 86 rises very steeply. The dashed curve 88 follows the real speed profile 86 virtually without delay, while the dotted line 89 has a significant time offset.

As a result of the criteria of the analysis of the measured values, switching over of the filter parameter sets is carried out here during the processing of the measured values, wherein up to approximately 14.765 seconds the dotted curve profile 89 is used for the control, and in which switching from the curve 89 to the curve 88 takes place starting at approximately 14.765 seconds. The switching time 78 is shown. At this time, the measured speed and/or the measured acceleration has exceeded a predetermined amount, and a different filter parameter set is therefore selected. In all cases, more than two filter parameter sets are also possible, for example one with relatively low filtering or smoothing, one with medium filtering or smoothing and one with relatively strong filtering or smoothing.

The control profile is represented by the crosses 87 which are shown, wherein the crosses 87 firstly lie on the curve 89 (relatively strong smoothing) and later on the curve 88 (relatively weak smoothing). It is therefore possible for sufficient correspondence and high accuracy to be achieved over the entire measuring range.

In particularly simple cases, for example relatively strong smoothing can comprise simple averaging of the last five or ten measured values, while in the case of relatively weak smoothing only the last two or three values are averaged. In this context, the intensity of the weighting can depend on the time interval (weighting of, for example, 25%, 50 and 100% for the penultimate measured value, the last measured value and the current value).

FIG. 9b shows the first time segment from FIG. 9 in an enlarged view, with the result that the deviations of the curve 88 from the real speed profile 86 can be seen very clearly. At the time of approximately 14.713 seconds on the curve 88, a speed value which is four times as high as the speed value which is actually present in reality is output. At this time, a deviation of the curve 89 from the real speed 86 is very much smaller.

FIG. 9c shows the profile of the relatively strong shock at the end of the time period illustrated in FIG. 9a, wherein a good degree of correspondence between the curve profiles 88 and the real speed profile 86 can be seen here. The time offset 97 between the maximum of the real speed profile 86 and the maximum of the curve 89 is much more than 5 ms and is too large to make available optimum damping properties for such shocks.

Overall, the invention provides a sufficiently fast and smooth response behavior which is respectively adapted, and therefore an improved damper device 100, in all power ranges of the dampers 1, by means of a sensor device 20 with high measuring resolution and by means of the filtering of the measurement data, wherein the filter parameters are selected as a function of the measurement data. The control in real time can be improved considerably, since the quality of the (measurement) signals used is improved, as a result of which a raw spring compression process, which it has been possible to perceive hitherto in some situations, during damping can be considerably reduced and virtually eliminated.

List of reference symbols:

| | |
|---|---|
| 1 | Damper |
| 2 | Damper housing |
| 3 | First damper chamber |
| 4 | Second damper chamber |
| 5 | Damping piston |
| 6 | Piston rod |
| 7 | Damping duct, flow duct |
| 8 | Damping valve |
| 10 | Damper characteristic curve |
| 11 | Electrical coil device |
| 12 | Control circuit |
| 18 | Direction of movement |
| 19 | Position |
| 20 | Sensor device |
| 21 | Detector head |

| | |
|---|---|
| 22, 23 | Detector |

| | |
|---|---|
| 26 | Magnetic field generating device |
| 27 | Sensor signal |
| 28 | Speed signal |
| 29 | Acceleration signal |
| 30 | Scaling device |
| 31 | Measuring section |
| 32 | Structure |
| 33 | Sensor section |
| 34 | Length |
| 35 | Field-generating unit |
| 36 | Annular conductor |
| 37 | Suspension piston |
| 38 | Cable |
| 39 | Position mark |
| 42 | Spring device |
| 43 | Positive chamber |
| 44 | Negative chamber |
| 45 | Memory device |
| 46 | Control device |
| 47 | Acceleration sensor |
| 49 | Display |
| 50 | Damper characteristic curve |
| 52 | Step |
| 53 | Internet |
| 54 | Network interface |
| 55 | Radio network interface |
| 56 | Step |
| 57 | Touchscreen, graphic operator control unit |
| 58 | Mount |
| 60 | Control device |
| 61 | Battery unit |
| 63 | Section |
| 64 | Filler material |
| 65 | Tip |
| 66 | Conductor |
| 67 | Insulator |
| 70 | Step |
| 71 | Equalization space |
| 72 | Equalization piston |
| 76 | Spring housing |
| 77 | Cover |
| 78 | Switching point |
| 79 | Diagram |
| 80 | Filter device |
| 81 | Analysis device |

| | |
|---|---|
| 82, 83 | Filter parameter set |

| | |
|---|---|
| 84 | Kalman filter |
| 85 | Average value former |
| 86 | Real speed |
| 87 | Speed used |

| | |
|---|---|
| 88, 89 | Speed |
| 90, 91 | Measurement data set |
| 92, 93 | Stored data set |
| 94, 95 | Control data set |

| | |
|---|---|
| 96 | Limiting value set |
| 97 | Time offset |

| | |
|---|---|
| 98, 99 | Computing unit |

| | |
|---|---|
| 100 | Damper device |
| 101 | Connecting unit |
| 102 | Connecting unit |
| 103 | Damper stroke |
| 111 | Wheel, front wheel |
| 112 | Wheel, rear wheel |
| 113 | Frame |
| 114 | Suspension fork |
| 115 | Rear wheel damper |
| 116 | Handlebars |
| 117 | Saddle |
| 150 | Operator control device |
| 151 | Activation device |
| 152 | Adjustment device |
| 160 | Smart phone |
| 200 | Two-wheeled vehicle |

1-25. (canceled)

26. A damper device, comprising:
two connecting units which can move relative to one another;
at least one controllable damper with a magneto-rheological fluid disposed for damping relative movements of said two connecting units, said damper having at least one first damper chamber and at least one damping valve with at least one damping duct;
a magnetic field generating device assigned said at least one damping valve and configured to generate and control a magnetic field in said at least one damping duct of said damping valve;
said magneto-rheological fluid being disposed in said at least one damping duct;
a control device and a memory device;
a sensor device disposed for acquiring measurement data sets relating at least to a relative movement of said connecting units with respect to one another; and
a filter device connected to said sensor device for pre-processing the measurement data sets,
wherein at least one data set, derived from a measurement data set acquired with said sensor device during the relative movement of said connecting units, is stored in said memory device;
an analysis device configured to analyze at least one stored data set and to determine a filter parameter set as a function of the result of the analysis; and
wherein said control device is configured to derive a control data set from the measurement data set with the filter parameter set, and said control device controlling the damper device with the control data set.

27. The damper device according to claim 26, wherein the derived data set comprises a speed signal and an acceleration signal for a relative movement of the connecting units, and wherein the control device is configured to select a filter parameter set with relatively strong filtering in the case of speed signals and acceleration signals which are relatively low in absolute value, and to select a filter parameter set with less filtering in the case of speed signals or acceleration signals which are relatively high in absolute value.

28. The damper device according to claim 26, wherein a multiplicity of filter parameter sets are stored in said memory device, and wherein a filter parameter set can be selected as a function of the at least one stored data set.

29. The damper device according to claim 26, wherein said analysis device comprises a comparator device configured to compare at least one stored data set with comparison data and to select, as a function of the result of the comparison, a filter parameter set stored in the memory device, and to derive a control data set from the measurement data set.

30. The damper device according to claim 26, wherein said memory device is configured to store therein a multiplicity of data sets.

31. The damper device according to claim 26, wherein the control device is configured to derive a speed signal for a relative movement of the connecting units from a sensor signal.

32. The damper device according to claim 26, wherein the control device is configured to derive an acceleration signal from a sensor signal.

33. The damper device according to claim 26, wherein said sensor device is configured to acquire a travel signal.

34. The damper device according to claim 26, wherein said sensor device is configured to acquire the travel signal with a resolution of better than 100 μm.

35. The damper device according to claim 26, wherein said sensor device is configured to acquire the sensor signal with a measuring frequency of at least 1 kHz.

36. The damper device according to claim 26, wherein said damper is formed with at least one first and at least one second damper chamber, and wherein said first damper chamber and said second damper chamber are coupled to one another via said at least one damping valve.

37. A method of controlling the damping of a relative movement between two connecting units, wherein the connecting units are mounted for movement relative to one another and wherein at least one controllable damper with a damping valve with a magneto-rheological fluid is provided for damping the relative movements, and wherein a magnetic field-generating device is assigned to the at least one damping valve for generating and controlling a magnetic field, the method which comprises:
acquiring and pre-processing with a filter device measurement data sets relating to a relative movement of the connecting units with respect to one another;
deriving at least one data set from an acquired measurement data set and storing the at least one data set in a memory device;
analyzing at least one stored data set and determining a filter parameter set as a function of the result of the analysis; and
deriving a control data set from the measurement data set with the selected filter parameter set, and controlling the damper device with the control device at least partially with the control data set.

38. The method according to claim 37, which comprises deriving acceleration signals are derived from the measurement data set.

39. The method according to claim 37, which comprises deriving speed data from the measurement data set.

40. The method according to claim 37, wherein a measurement data set is filtered more strongly when an absolute value of the values of the measurement data set is lower than when the absolute value of the values of the measurement data set is higher.

41. The method according to claim 40, wherein stronger filtering is carried out in the case of relatively low speeds than in the case of relatively high speeds.

42. The method according to claim 40, wherein stronger filtering is carried out in the case of relatively low accelerations than in the case of relatively high accelerations.

43. The method according to claim 37, which comprises storing a plurality of successively acquired data sets.

44. The method according to claim 37, which comprises determining the control data set by smoothing a plurality of data sets.

45. The method according to claim 44, wherein an intensity of the smoothing depends on the stored data set.

46. The method according to claim 37, wherein the sensor device acquires measurement data sets with a measuring frequency of higher than 1 kHz and/or wherein the control device determines control data sets with a control frequency of higher than 1 kHz and actuates the damper device at least temporarily with at least the control frequency.

47. The method according to claim 46, wherein the measuring frequency and/or the control frequency are/is higher than 5 kHz.

48. The method according to claim 46, which comprises acquiring the travel signals with the sensor device at a resolution of less than 100 μm or less than 50 μm.

49. The method according to claim 46, wherein the measuring frequency and the control frequency are at least temporarily higher than 8 kHz and the resolution of the travel signals is at least temporarily less than 5 μm.

50. The method according to claim 46, wherein the measuring frequency is less than 50 kHz or less than 20 kHz.
